(19) United States
(12) Patent Application Publication
(10) Pub. No.: US 2005/0128969 A1
(43) Pub. Date: Jun. 16, 2005

(54) Handover method and handover apparatus

(75) Inventors: Min-ho Lee, Seoul (KR); Pyung-soo Kim, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/923,731

(22) Filed: Aug. 24, 2004

(30) Foreign Application Priority Data
Dec. 10, 2003 (KR) 2003-89362

(51) Int. Cl. H04Q 7/00; H04Q 7/24; H04J 3/24; H04L 12/66

(52) U.S. Cl. 370/313; 370/349; 370/352

(57) ABSTRACT

Communication handover methods and apparatuses for use in an environment involving terminals having mobile nodes moving at a high speed. The handover method includes actively requesting handover to an access router based on the moving speed of a mobile node. The handover methods and apparatuses reduce handover latency and packet losses in a handover process of a terminal moving at a high speed.

### CROSS-REFERENCE TO RELATED APPLICATIONS

This application claims priority of Korean Patent Application No.2003-89362, filed on Dec. 10, 2003 in the Korean Intellectual Property Office, the disclosure of which is incorporated herein by reference.

### BACKGROUND OF THE INVENTION

1. Field of the Invention

The present invention relates to a handover method and apparatus in a mobile Internet protocol (IP) version 6 (IPv6) environment, and more particularly, to handover methods and handover apparatuses for a fast-moving terminal in a mobile IPv6 environment.

2. Description of the Related Art

Recently, wireless network access has been a field of increasing interest because it allows nodes to move at a reasonable speed during communications and accessing a network.

FIG. 1 is a reference diagram to explain the structure of the prior art IPv6 wireless network. Mobile IPv6 is designed to manage movement of a mobile node among IPv6 networks.

Referring to FIG. 1, when a mobile node 100 is in its home network determined as a cell of an access router (AR), old AR 110, the mobile node 100 communicates with a correspondent node, as an IPv6 node. However, when the mobile node 100 moves to another subnet determined as a cell of a new AR 120, the home address of the mobile node 100 is not valid any more and packets transmitted by the correspondent node are transferred to the previous home network. Accordingly, the mobile node 100 should obtain care-of address (CoA) that is a new valid address in the subnet being visited by the mobile node 100 and should register this new care-of address in its home agent 130 and the correspondent node. Thus connecting the home address of the mobile node and the current care-of address is referred to as “binding”.

The moving of a mobile node among access points belonging to an identical subnet is managed by layer 2 (L2) protocol. Meanwhile, if a mobile node is connected to an access point (AP) in another subnet, the IPv6 address of the mobile node is not valid any more, and this kind of moving should be managed by L3 protocol. L3 protocol provides a seamless connection, called L3 handover, to an IPv6 mobile node when the mobile node moves from one wireless point to another wireless point in another subnet.

The handover procedure will now be explained briefly. A mobile node analyzes router advertisement which is sent periodically by an access router, and thus detects whether or not the mobile node has moved to a new subnet. The mobile node may ask the access router to send a router advertisement, by sending a router solicitation message. Information contained in this router advertisement helps the mobile node generate a new care-of address. The mobile node performs address generation based on given information. First, address automatic formation is performed with a link local address and a network prefix included in router advertisement, and then redundant address detection is performed with this address to verify that this address is unique.

However, the mobile node is unable to receive an IP packet at the new point unless the handover is finished. This time comprises a time taken to detect a new prefix in a new subnet, a time taken to set a new care-of address, and a time taken to notify the new location of the mobile node to a correspondent node and the home agent, and is referred to as ‘handover latency’.

Actually, this handover latency may be too long in real time multimedia applications. In many cases, this handover latency may greatly degrade the quality of IPv6 streams of a mobile node.

A concept of fast handover has been introduced to reduce the handover latency and packet losses due to this handover of a mobile node.

Since the drawbacks are caused by the fact that the conventional handover method performs handover by using only layer 3 information, the fast handover method is intended to more actively perform a handover process by using layer 2 information. In order to optimize the moving of a mobile node, fast handover performs handover in two methods: one is an anticipated handover using L2 trigger, and the other is a tunnel-based handover.

In the anticipated handover method, the fact that a mobile node has moved to a new network is not recognized by receiving a router advertisement signal, but by receiving a signal (L2 trigger) in layer 2 at a moment when the mobile node moves into a new network. By doing so, changes in the network situation can be recognized a little earlier such that the handover can be performed.

FIG. 2 is a reference diagram to explain “anticipated handover” among related high speed handover methods.

Referring to FIG. 2, in the anticipated handover method, a mobile node 200 or a current access router 230 receives the L2 trigger indicating that the mobile node 200 is to perform the L2 handover. This trigger contains information allowing identification of a target access router 240.

If a mobile node 200 receives the L2 trigger, the mobile node 200 begins the handover, and asks a current access router 230 for a fast handover. Then, the current access router 230 transmits an IPv6 address available in a new subnet to the mobile node 200 and a target access router 240.

Then, the target access router 240 verifies whether or not the received address is available in the subnet and if available, transmits the verification result to the current access router 230. If the address is available, the current access router 230 transmits to the mobile node 200 an authentication message indicating that the address can be used.

When the mobile node establishes a connection to the new access point 220, the mobile node can immediately use a new CoA as the source address of an outbound packet and transmit a binding update to the home agent and a correspondent node.

Tunnel-based handover enables routers of an existing network and a new network to form a channel to each other, and to process packets through this channel during handover generating a CoA. This method delays generation of a CoA and utilizes the existing CoA till a new communication connection is established, such that packet losses can be reduced.

FIG. 3 is a reference diagram to explain “tunnel-based handover” among related art high speed handover methods. Referring to FIG. 3, in the tunnel-based handover method, when a mobile node 300 moves from a current access router AR0 310 to a new access router AR1 320, the mobile node 300 delays setting a new CoA. Accordingly, the mobile node 300 performs only the L2 handover and continues to use the previous CoA in the new subnet. In addition, the mobile node 300 does not need to exchange any packet. Two access routers AR0 310 and AR1 320 set a bidirectional tunnel from the L2 trigger without interaction with the mobile node 300. Packets transmitted to the mobile node arrive at the previous subnet and are forwarded to the new access router AR1 320 by the previous access router AR0 310. Packets transmitted by the mobile node follow the reverse path from the new access router AR1 320 to the previous access router AR0 310.

Then, the mobile node generates and registers a CoA while performing communications. The use of the L2 trigger enables an access router to detect the moving of a mobile node without a need to transmit any packet. Interface with a third access router AR2 330, as the mobile mode 300 moves, is carried out in a similar manner.

Meanwhile, as the use of IPv6 is being diversified, it is expected that IPv6 terminals will be installed in high-speed modes of transportation such as automobiles and high-speed trains. Terminals moving fast usually have directivity, by which those that are moving travel in a predetermined direction, thus, the motion can be predicted in such special situations.

Fast handover according to the two concepts of anticipated handover and tunnel-based handover as described above can solve many of the problems of the conventional mobile IPv6 handover process. However, it cannot solve all the problems and in particular, in a terminal moving at a high speed, there are additional problems.

For example, in the case of anticipated handover, the effect is maximized when a mobile node begins handover at an L2 trigger time point and already finishes the handover process when the mobile node cannot receive a packet from the previous network and has to use a new network. In this case, the handover process should begin earlier than the L2 trigger time point. When the speed of the mobile node is very high, there may be such a case where a mobile node has already moved to another network when handover is finished. Accordingly, a solution for a fast-moving terminal which needs faster beginning of handover has not been provided.

Also in the case of tunnel-based handover, in a situation where there are many fast-moving terminals, the load to form a channel becomes very large in each router. In addition, because a router should manage channel information for each mobile terminal, the load to a router becomes more serious on a freeway or high-speed train where fast-moving terminals are crowded. Accordingly, in order to provide a smooth handover function to a fast-moving terminal, a handover process which has an earlier handover beginning time, and puts less of a load on a router is needed.

Also, since major applications include VoIP and multimedia streaming, a real-time transmission concept reducing packet losses as much as possible while a packet can arrive at a receiver at a time when the transmitter and receiver want is also needed for operations of a variety of applications.

### SUMMARY OF THE INVENTION

In an aspect of the present invention, a handover method and handover apparatus which can reduce handover latency and packet losses for a fast-moving terminal in a mobile IPv6 environment are provided.

According to an aspect of the present invention, there is provided a handover method including requesting handover to an access router based on the moving speed of a mobile node.

In an aspect, the requesting handover operation includes measuring the moving speed of the mobile node, or obtaining the moving speed of the mobile node by calculating the moving speed of the mobile node based on time information of the time when the mobile node is connected to the IP of routers visited by the mobile node.

In an aspect, the requesting handover also includes determining a handover mode for a fast-moving terminal which begins a handover operation before an L2 trigger of the mobile node based on the obtained moving speed data; and if the handover mode for a fast-moving terminal is determined, generating and transmitting a care-of address (CoA) request message before the L2 trigger of the mobile node.

According to another aspect of the present invention, there is provided a handover method provided to an access router including performing tunneling so that access routers on a path to a destination access router participate in tunneling, based on the destination access router information of a mobile node.

In an aspect, performing tunneling includes receiving a CoA request message including the destination access router information from the mobile node; transmitting a CoA request message having the destination access router as a destination; receiving a CoA response message from an intermediate access router which receives the CoA request message; and transmitting a duplicated packet of a packet directed to the mobile node, to the intermediate access router.

According to another aspect of the present invention, there is provided a handover method provided to an access router including a mobile node predicting an access router to be connected by the mobile node, based on information on access routers visited by the mobile node, and by using the predicted access router, performing handover.

In an aspect, the handover method further including receiving a CoA message including information on access routers visited by the mobile node, from the mobile node; predicting an access router to be connected by the mobile node, based on the access router information included in the CoA message; transmitting a CoA request message having the predicted access router as a destination; receiving a CoA response message from the predicted access router which receives the CoA request message; and transmitting a duplicated packet of a packet directed to the mobile node, to the predicted access router.

In an aspect, the handover method further including receiving a CoA message including information on access routers visited by the mobile node, from an access router; predicting a next access router to be connected by the mobile node, based on the moving speed information of the mobile node included in the CoA message; transmitting a CoA request message having the predicted access router as a destination; receiving a CoA response message from the predicted access router which receives the CoA request message; and transmitting a duplicated packet of a packet directed to the mobile node, to the predicted access router.

According to another aspect of the present invention, there is provided a handover method including at a first time point of an L2 trigger, receiving a CoA request message, which is received from a mobile node by a previous access router, from the previous access router, generating a CoA, and receiving a duplicated packet directed to the mobile node from the previous access router using the generated CoA; and at a second time point of the L2 trigger, transmitting the duplicated packet using the CoA, in response to a release request from the mobile node.

In an aspect of the handover method, the first time point of the L2 trigger indicates a time when the strength of an L2 signal corresponding to a cell which the mobile node belongs to currently goes down below a lower threshold and at the same time the strength of an L2 signal corresponding to a next cell goes up above an upper threshold, and the second time point of the L2 trigger indicates a time when the strength of an L2 signal corresponding to a cell which the mobile node belongs to currently goes down below an upper threshold and at the same time the strength of an L2 signal corresponding to a next cell goes up above a lower threshold.

According to a further aspect of the present invention, there is provided a handover apparatus provided to a mobile node including a handover booster which requests handover to an access router based on the moving speed of the mobile node.

According to an aspect of the present invention the handover apparatus, the handover booster includes a moving speed calculation/measurement unit which calculates or measures the moving speed of the mobile node.

According to an aspect of the present invention, the handover apparatus, the moving speed calculation/measurement unit includes a moving speed measurement unit which has a sensor for measuring the moving speed of the mobile node.

According to an aspect of the present invention the handover apparatus, the moving speed calculation/measurement unit includes a moving speed calculation unit which calculates the moving speed of the mobile node based on time information on the time when the mobile node is connected to the IP of routers visited by the mobile node.

According to an aspect of the present invention the handover apparatus the handover booster includes a handover mode determination unit which determines a handover mode for a fast-moving terminal which begins a handover operation before L2 trigger of the mobile node based on the moving speed data output by the moving speed calculation/measurement unit; and a handover request unit which if the handover mode determination unit determines the handover mode for a fast-moving terminal, generates and transmits a CoA request message before L2 trigger of the mobile node.

In an aspect of the present invention CoA request message includes the moving speed of the mobile node and information providing the destination of the mobile node.

According to an additional aspect of the present invention, there is provided handover apparatus provided to an access router including a pre-handover agent which performs tunneling so that access routers on a path to a destination access router participate in tunneling, based on the destination access router information of a mobile node.

In an aspect of the present invention, in the handover apparatus, a duplicated packet directed to the mobile node is transmitted to the access routers participating in the tunneling.

According to an additional aspect of the present invention, there is provided a handover apparatus provided to an access router comprising a pre-handover agent which predicts an access router to be connected by the mobile node, based on information on access routers visited by the mobile node, and requests handover to the predicted access router.

### BRIEF DESCRIPTION OF THE DRAWINGS

The above aspects and/or advantages of the present invention will become more apparent by describing in detail exemplary embodiments thereof with reference to the attached drawings of which:

FIG. 1 is a reference diagram to explain the structure of the conventional IPv6 wireless network;

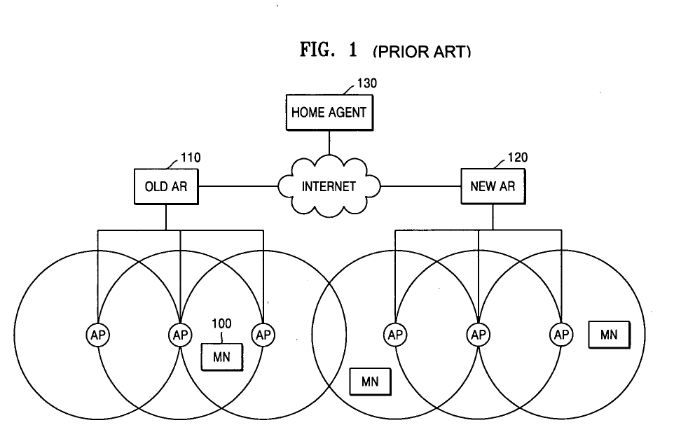

FIG. 2 is a reference diagram to explain “anticipated handover” among conventional high speed handover methods;

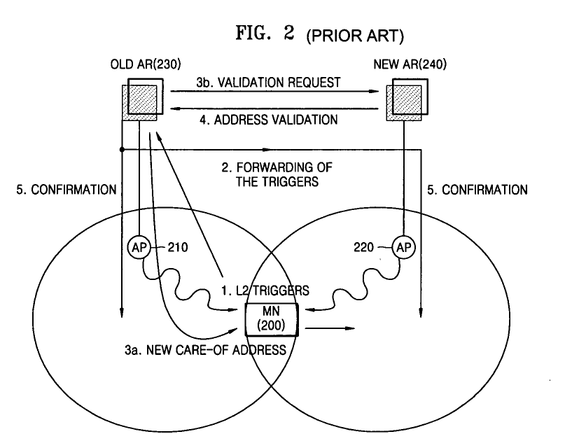

FIG. 3 is a reference diagram to explain “tunnel based handover” among conventional high speed handover methods;

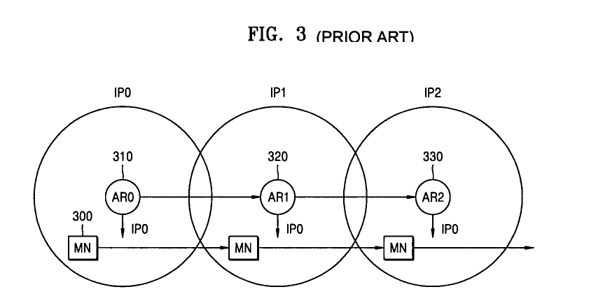

FIG. 4 is a reference diagram to explain a pre-handover method for a terminal moving at a high speed according to an embodiment the present invention;

FIG. 5 is a block diagram showing an example of the structure of communication devices performing a pre-handover method according to an embodiment the present invention;

FIG. 6 is a block diagram showing an example of a detailed structure of the handover booster shown in FIG. 5 according to an embodiment of the present invention;

FIG. 7A is a block diagram showing an embodiment of a detailed structure of the moving speed calculation/measurement unit shown in FIG. 6 according to an embodiment of the present invention;

FIG. 7B is a block diagram showing another embodiment of a detailed structure of the moving speed calculation/measurement unit shown in FIG. 6 according an embodiment of to the present invention;

FIG. 8 is a reference diagram to explain a packet to which a handover message according to an embodiment the present invention is applied;

FIG. 9 is a diagram of the structure of a handover message according to an embodiment of the present invention;

FIG. 10 is a block diagram showing an example of a detailed structure of pre-handover agent of an access router shown in FIG. 5;

FIG. 11 is a reference diagram to explain router information of the access routers shown in FIG. 5;

FIG. 12 is a flowchart of a pre-handover operation method according to an embodiment of the present invention;

FIG. 13 is a flowchart of the operations performed by a tunneling operation method according to an embodiment of the present invention;

FIG. 14 is a diagram of a message flow according to an embodiment of the tunneling operation method of FIG. 13;

FIG. 15 is a diagram of a message flow according to another embodiment of the tunneling operation method of FIG. 13; and

FIG. 16 is a diagram of a message flow according to another embodiment of a tunneling operation method.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

In an aspect of the present invention, the care-of address (CoA) establishing process from automatic formation to duplicated address detection (DAD), which takes a significant amount of time in a handover process, is performed in advance so that immediately after an L3 handover occurs, a mobile node can use a new CoA.

In addition, considering that fast-moving terminals usually have predetermined directivity, a bicasting technique which is used mainly for layer 2 in the conventional applications is expanded by applying a layer 3 tunneling technique in an aspect of the present invention. That is, in order to establish a route to a destination based on the directivity of a fast-moving mobile node, the speed of a terminal is measured by a time for connection between access routers and the fast-moving terminal so that even when the speed of the terminal increases, layer 3 handover can be performed in an appropriate time.

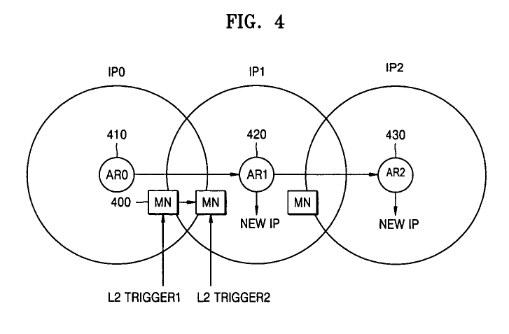

FIG. 4 is a reference diagram to explain a handover method for a fast-moving terminal according to an embodiment of the present invention. Referring to FIG. 4, access router (AR) AR0 410 belongs to the IP0 address network (cell 0), AR1 420 belongs to the IP1 address network (cell 1), and AR2 430 belongs to the IP2 address network (cell 2).

When an upper threshold and lower threshold are determined for an L2 signal, both an L2 trigger 1 and an L2 trigger 2 are used. The L2 trigger1 indicates a time point when a current L2 signal corresponding to a current cell goes down below the upper threshold and at the same time a next L2 signal corresponding to the next cell goes up over the lower threshold. The L2 trigger2 indicates a time point when the current L2 signal corresponding to the current cell goes down below the lower threshold and at the same time the next L2 signal corresponding to the next cell goes up over the upper threshold.

A mobile node 400 stores connection information whenever the mobile node 400 is connected to an access router (AR) in layer 2, and calculates the speed using the connection information. Meanwhile, when the mobile node 400 is connected to a new AR in layer 3, the speed calculation is performed in the same manner as in layer 2 and the speed of the mobile node 400 is calculated. At the L2 trigger 2 time point, a CoA to be used in the next cell is requested by the access router.

If the L2 trigger 1 occurs in cell 0, the mobile node 400 transmits a release request message to AR0 410. After receiving this message, AR0 410 transmits a release message to AR1 420, and AR1 420 begins to release packets by a new CoA of the mobile node 400, which are being received, by the network.

Next, if the L2 trigger 2 occurs between cell 0 and cell 1, the mobile node 400 transmits a CoA request message and receives a new CoA from AR1 420, and by receiving packets on the new CoA, completes the handover process between cell 0 and cell 1. At this time, AR1 420 which receives the CoA request message by the mobile node 400 according to the L2 trigger 2, analyzes the CoA request message and transmits the CoA request message to the access router AR2 430 which the mobile node is to be connected to next, so that the AR2 430 can generate a new CoA in advance. AR2 performs a job to generate the new CoA for the mobile node 400.

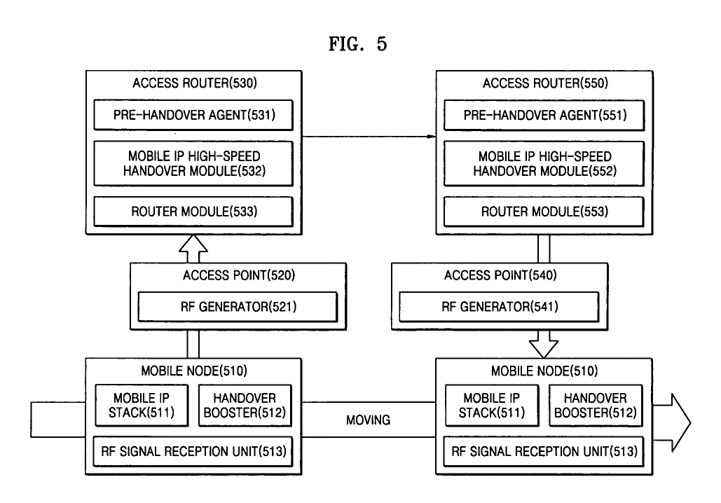

FIG. 5 is a block diagram showing an example of the structure of communication devices performing a handover method for a fast-moving terminal according an embodiment of to the present invention. Referring to FIG. 5, the communication devices performing the handover method for a fast-moving terminal includes a mobile node 510, an access point 520 and an access router 530.

The mobile node 510 comprises a mobile IP stack 511, a handover booster 512, and an RF signal transmission and reception unit 513. The mobile IP stack 511 stores mobile IP information, and the RF signal transmission and reception unit 513 communicates a signal with the access point 520. The handover booster 512 calculates the speed of a mobile terminal and according to the speed information performs a handover request. The handover booster will be explained in detail later.

The access point 520 comprises an RF generator 521 which is provided so as to transmit and receive a signal between the access router 530 and the mobile node 510.

The access router 530 comprises a pre-handover agent 531, a mobile IP high-speed handover module 532, and a router module 533. The mobile IP high-speed handover module 532 performs the conventional high-speed handover operation, and the router module 533 provides the router function of an access router. The pre-handover agent 531 provides fast layer 3 handover function for a fast-moving terminal. The pre-handover agent 531 will be explained in detail later.

The handover operation for a fast-moving terminal according to the structure of communication devices shown in FIG. 5 will now be explained. Based on the moving speed of the mobile node 510 and destination information, the handover booster 512 of the mobile node 510 transmits a CoA request message to the access router 530 through the access point 520 at an L2 trigger 2 time point.

The pre-handover agent 531 of the access router 530 responds to the mobile node 510 with a CoA which the pre-handover agent 531 has already generated in the previous operation. Also, in order that the mobile node 510 can receive the CoA directly from an access router to be connected next, the pre-handover agent 531 analyzes the received CoA request message, determines the destination of the mobile node 510 and others, and requests the pre-handover agent 551 of another access router 550 to generate a CoA. If a CoA response from the pre-handover agent 551 is received, the pre-handover agent 531 transmits duplicated data of packet data directed to the mobile node 510 with the CoA as the destination address, to the pre-handover agent 551.

If the mobile node 510 moves and then makes a release request to the access router 530 at an L2 trigger 1 time point, the access router 550 transmits the received duplicated packet data to the mobile node 510 through the access point 540 by using the already generated CoA.

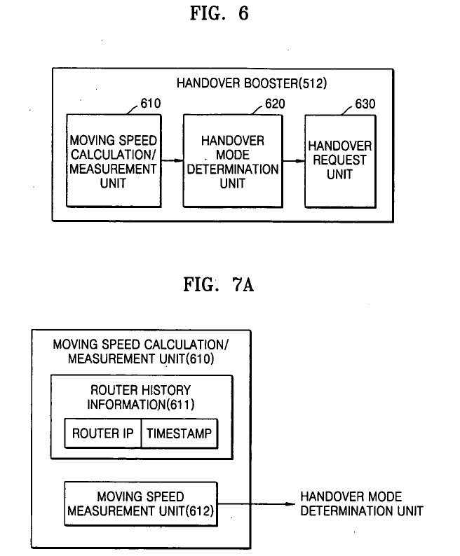

FIG. 6 is a block diagram showing an example of a detailed structure of the handover booster shown in FIG. 5 according to an embodiment of the present invention. Referring to FIG. 6, the handover booster 512 comprises a moving speed calculation/measurement unit 610, a handover mode determination unit 620, and a handover request unit 630.

The moving speed calculation/measurement unit 610 calculates or measures the speed of a mobile node 510, based on layer 2 and layer 3 handover information, and continuously stores and manages the information in a database (not shown).

The handover mode determination unit 620 receives information on the speed of a mobile node 510 calculated by the moving speed calculation/measurement unit 610, and based on this, determines a handover mode. For example, if the speed exceeds a predetermined threshold, a handover mode for a fast-moving terminal is determined and if the speed does not exceed the predetermined threshold, a handover mode for an ordinary mobile terminal can be determined.

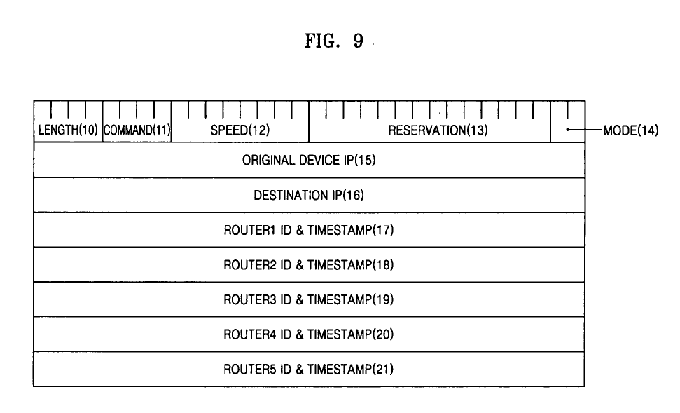

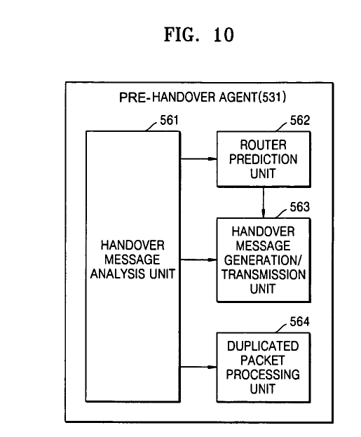

The handover request unit 630 receives the determined mode from the handover mode determination unit 620, and if it is the handover mode for a fast-moving terminal, generates and transmits a handover message used in a handover method for a fast-moving terminal, and if it is the handover mode for an ordinary mobile terminal, generates and transmits the conventional handover message. The handover message used in the handover method for a fast-moving terminal according to an embodiment of the present invention will be explained in detail referring to FIGS. 8 and 9.

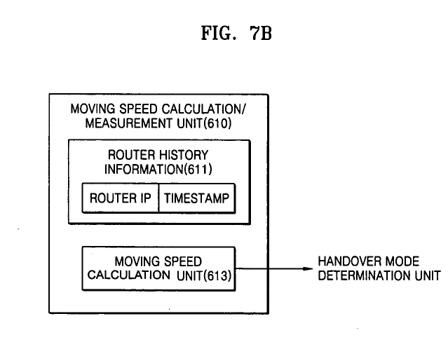

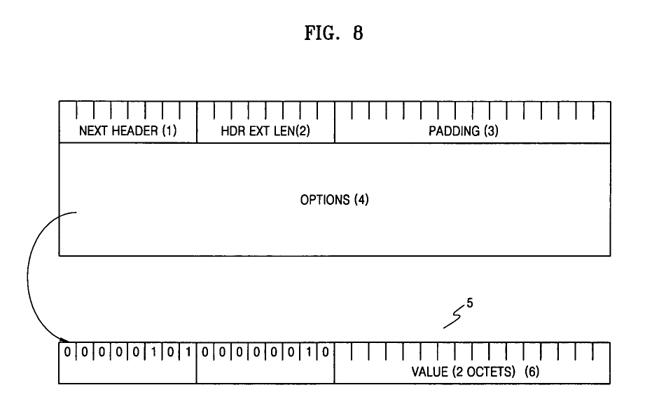

FIG. 7A is a block diagram showing an embodiment of a detailed structure of the moving speed calculation/measurement unit shown in FIG. 6 according to an embodiment of the present invention.

Referring to FIG. 7A, the moving speed calculation/measurement unit 610 comprises a router history information 611 and a moving speed measurement unit 612. The router history information 611 contains the layer 2 and layer 3 handover information described above. Layer 3 handover information includes information on routers visited previously by a mobile node, that is, each router IP and the timestamp which is speed information when the mobile node is connected to the router. Layer 2 handover information includes information on access points visited by the mobile node till now, that is, each access point IP and the timestamp which is speed information when the mobile node is connected to the access point. This router history information 611 comprises history information of about five routers including the router immediately before the current router connected to the mobile node.

The moving speed measurement unit 612 has a sensor measuring the moving speed of a mobile node and measures the moving speed. With this sensor, it is not needed to separately calculate the moving speed by using the router history information.

FIG. 7B is a block diagram showing another embodiment of a detailed structure of the moving speed calculation/measurement unit shown in FIG. 6 according to an embodiment of the present invention. Referring to FIG. 7B, the moving speed calculation/measurement unit 610 comprises a router history information 611 and a moving speed calculation unit 613.

The router history information 611 is the same as described above in referring to FIG. 7A. The moving speed calculation unit 613 calculates a speed based on each distance between routers and timestamps included in the router history information 611. In addition, by comparing a speed change using the layer 2 handover information with a speed change using the layer 3 handover information, the moving speed calculation unit 613 can finally modify the speed of a mobile node.

FIG. 8 is a reference diagram to explain the structure of a packet header of a handover message for a fast-moving terminal according to an embodiment of the present invention. A handover message comprises a packet header and contents.

The packet header complies with the standard IPv6 header structure and uses a hop by hop option header. The structure of a hop by hop extended header is as shown in FIG. 8.

Next Header 1 is used to recognize a next header, Hdr Ext Len 2 indicates the length of an extended header, Padding 3 is a padding area to match the number of bits, and Options 4 defines an option.

The option field may use a router warning option defined in the standard. According to the standard, in Value 6 of the router warning option indicated by reference number 5, because 0, 1, 2 are already bound to other purposes, values from 3 to 65535 can be used. In order to be used for aspects of the present invention, the value of Value 6 can use any one of the values from 3 to 65535 excluding 0, 1, and 2.

Both a mobile node and a router form the packet headers of the structure shown in FIG. 8 to generate the handover message packet.

FIG. 9 shows the structure of the contents of a handover message according to an embodiment of the present invention. Referring to FIG. 9, the contents of a handover message include a length 10, a command 11, a speed 12, a reservation 13, a mode 14, an original device IP 15, a destination IP 16, and router ID & timestamps 17 through 21.

The length 10 indicates with 4 bits the length of the entire handover message.

The command 11 indicates a packet for a situation determined by two bits. Bits of 00 indicate a CoA request message transmitted by a mobile node to an access router, bits of 01 indicate a CoA request message transmitted by the access router to another access router in a different network, bits of 10 indicate a CoA response message transmitted to the access router from another access router in a different network, and bits of 11 indicate a CoA response message transmitted by the access router to the mobile node. For a CoA response message, CoA information is further included in a message, though not shown in FIG. 9.

The speed 12 indicates the speed of the mobile node with 10 bits.

The reservation 13 is a 14-bit space made to be empty for other purposes and also has a function of padding to make a 32-bit string.

The mode 14 indicates with 2 bits whether or not there is a final destination. For example, bits of 01 indicate that there is a final destination and 00 can indicate that an intermediate destination should be estimated continuously. When there is a predetermined destination, such as a case when a mobile node uses a freeway, a high-speed train, or an automatic path guide system using a global positioning system (GPS), an indication that destination information is included is written in the mode 14 field of a CoA request message, and final destination information is written in the destination IP 16 field of the handover request message.

The original device IP 15 indicates the initial IP of a mobile node with 128 bits, and is used by access routers to recognize the mobile node regardless of CoA changes.

The destination IP 16 indicates the final destination IP by 128 bits and, if there is no final destination, can be filled with zeros.

Each router ID & timestamp 17 through 21 indicates history information of an access router visited by the mobile node with 64 bits, and includes the router ID and timestamp. For example, in the case where there is no predetermined destination such as in an ordinary trunk road, the handover booster 512 of the mobile node 510 writes information on the router path visited by the mobile node 510 till in the router ID & timestamps 17 through 21 field of the handover request message.

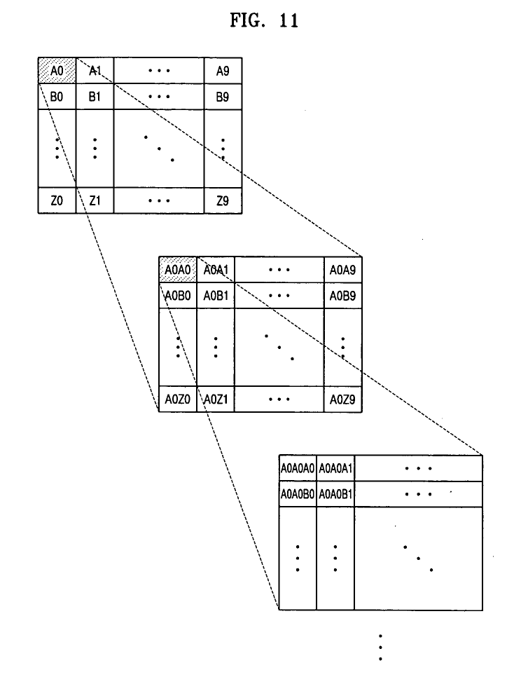

FIG. 10 is a block diagram showing an example of a detailed structure of the pre-handover agent of the access router shown in FIG. 5 according to an embodiment of the present invention. Referring to FIG. 10, the pre-handover agent 531 comprises a handover message analysis unit 561, a router prediction unit 562, a handover message generation/transmission unit 563, and a duplicated packet processing unit 564.

The handover message analysis unit 561 receives a handover message from the mobile node 510 or another access router 550, and analyzes the contents of the handover message. The handover message includes a CoA request message which requests a response on a CoA after generating the CoA, a CoA response message which responds to the CoA request message after generating another CoA as a response to the CoA request message, and a release request message which requests an access router to transmit duplicated packet data stored in the access router 530.

If the handover message is a CoA request message from the mobile node 510, the handover message analysis unit 561 secures an L3 tunneling channel by communicating with pre-handover agents 551 of other access routers 550. In this case, the handover message generation/transmission unit 563 generates and transmits a CoA request message to a destination router.

If the handover message analysis unit 561 receives a CoA request message from another access router 550, the handover message generation/transmission unit 563 transmits the received CoA message to a next access router (not shown) so that the received CoA message can be forwarded to the destination. In addition, by performing CoA autoconfiguration and duplicated address detection (DAD), a predetermined module (not shown) of the pre-handover agent 531 secures an address that can be used immediately when the mobile node 510 enters into an area managed by the pre-handover agent 531.

If the handover message analysis unit 561 receives a CoA response message from another access router 550, the handover message generation/transmission unit 563 transmits the received CoA response message to the mobile node 510, and by using the received CoA response message, the duplicated packet processing unit 564 transmits packets that are likely to be lost during the handover process, through the L3 tunneling channel established between access router 510 and 550, respectively. Meanwhile, this duplicated packet processing unit 564 receives a duplicated packet from another access router and stores it, and if the mobile node 510 transmits a release request by an L2 trigger 2, the duplicated packet processing unit 564 converts the packet into a packet having a new CoA of the mobile node 510 as a target address, and transmits the converted packet to the mobile node 510. A release request message is transmitted by the mobile node 510 to a current access router 530, and the current message transmits the release request to the next access router 550.

A CoA response message transmitted by an access router to the mobile node includes a newly generated CoA to be used by the mobile node. A CoA response message transmitted by an access router to another access router includes a CoA newly generated for the mobile node for receiving a duplicated packet.

If the received CoA request message includes the final destination, the handover message generation/transmission unit 563 generates a CoA request message to send to the final destination and transmits the CoA request message in a hop by hop method.

If a CoA request message includes only intermediate destination information, the router prediction unit 562 predicts a next access router to be connected to the mobile node by using the intermediate destination information. In addition, the router prediction unit 562 can predict two or more access routers to be connected by the mobile node according to the speed information of the mobile node included in the handover request message.

By using router information thus predicted by the router prediction unit 562, the handover request message generation/transmission unit 563 can generate a CoA request message with this predicted router as a destination and transmit.

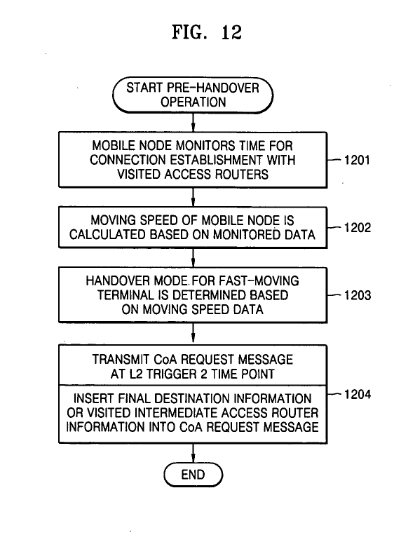

An example of a method for the router prediction unit 562 predicting a next router will now be explained referring to FIG. 11. FIG. 11 is a reference diagram to explain router information which the access router shown in FIG. 5 uses according to an embodiment of the present invention.

Location information of a router can be given by allocating a unique ID for each access router, and in router distribution allocation by area as shown in FIG. 11, Arabic numbers are arranged in the horizontal axis and the English alphabet letters are arranged in the vertical axis.

When an area to which an access router is allocated is divided in a 5-staged depth, an example of an ID allocated to an access router can be B2C6A1H7U9. By arranging the router information in this manner, the directivity of a router can be determined only by information on routers visited by the mobile node and an access router that should be connected next can be estimated. Each ID with the corresponding IP address of the router is managed in a table.

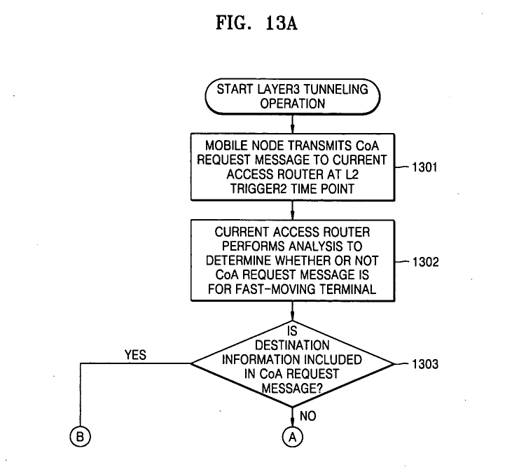

FIG. 12 is a flowchart of the operations performed by a pre-handover operation method according to an embodiment of the present invention.

The operations shown in FIG. 12 includes an operation requesting a CoA to an access router to obtain the CoA in advance when it is determined that the mobile node moves at a high speed, according to the moving speed of the mobile node before L2 trigger.

First, the handover booster 512 of the mobile node 510 monitors the time taken for establishing connections with the visited access routers in operation 1201, and calculates the moving speed of the mobile node 510 based on the monitored data in operation 1202.

Next, the handover booster 512 determines a handover mode for a fast-moving terminal based on the calculated moving speed data in operation 1203, and transmits a CoA request message to the access router 530 at the L2 trigger 2 time point in operation 1204. In this CoA request message, final destination information, or visited intermediate operation access router information and moving speed information of the mobile node are inserted as described referring to FIG. 9.

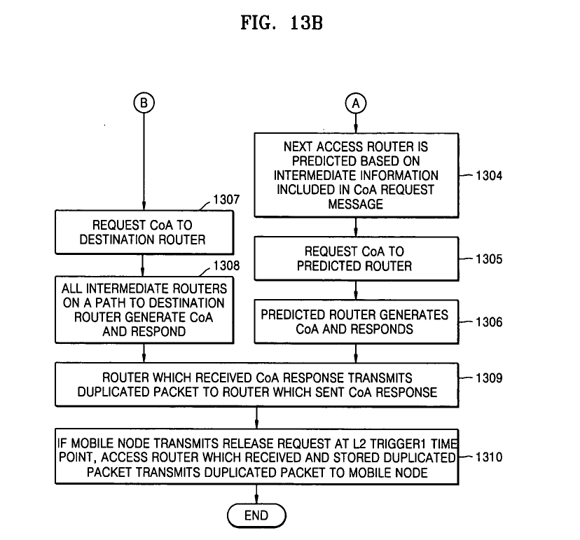

FIG. 13 is a flowchart of the operations performed by a tunneling operation method according to an embodiment of the present invention. The operations shown in FIG. 13 include a tunneling process between a current access router which receives a CoA request from the mobile node, and next routers.

Referring to FIG. 13, a mobile node transmits a CoA request message to a current access router at the L2 trigger 2 time point in operation 1301, the pre-handover agent 531 of the current access router 530 which receives a request message analyzes the received CoA request message to determine whether or not it is a CoA request message for a fast-moving terminal in operation 1302.

If the result of the analysis indicates that it is a CoA request message for a fast-moving terminal, the pre-handover agent 531 transmits a CoA response message as a response to the CoA request message, to the mobile node 510, by using a CoA which the pre-handover agent 531 has already generated in the previous operation.

Then, the pre-handover agent 531 determines whether or not destination information is included in the CoA request message in operation 1303, and if it is not included, predicts a next access router based on intermediate router information included in the CoA request message in operation 1304. Then, the pre-handover agent 531 transmits a CoA request to the predicted router 550 in operation 1305, and the pre-handover agent 551 of the predicted router 550 receives this CoA request, generates a CoA, and responds to the request in operation 1306.

If destination information is included in the CoA request message, the pre-handover agent 531 requests a CoA to the destination router by using the destination information in operation 1307. In the case where a CoA is thus requested to the final destination router, all routers on the path to the destination router determine by the hop by hop option header that the mobile node will come, and generate a new CoA, and respond in operation 1308.

The pre-handover agent 531 of the access router 530 which receives the CoA response transmits a duplicated packet of the packet directed to the mobile node in operation 1309.

If the mobile node 510 moves and transmits a release request to the access router 550 at an L2 trigger 1 time point, the access router 550 which has already received and stored a duplicated packet in the previous operation transmits a duplicated packet to the mobile node 510 in operation 1310.

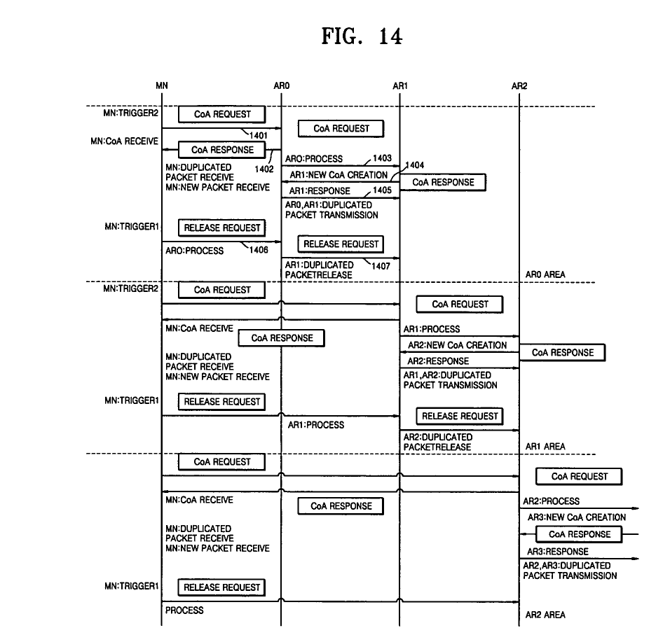

Operations performing handover among the access routers are explained above referring to the flowcharts shown in FIGS. 12 and 13A-13B, and more detailed handover operations will now be explained referring to FIGS. 14 through 16.

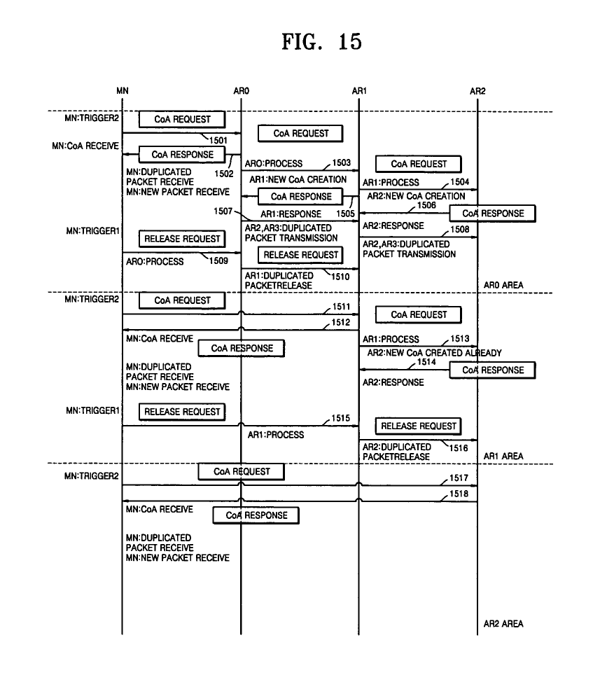

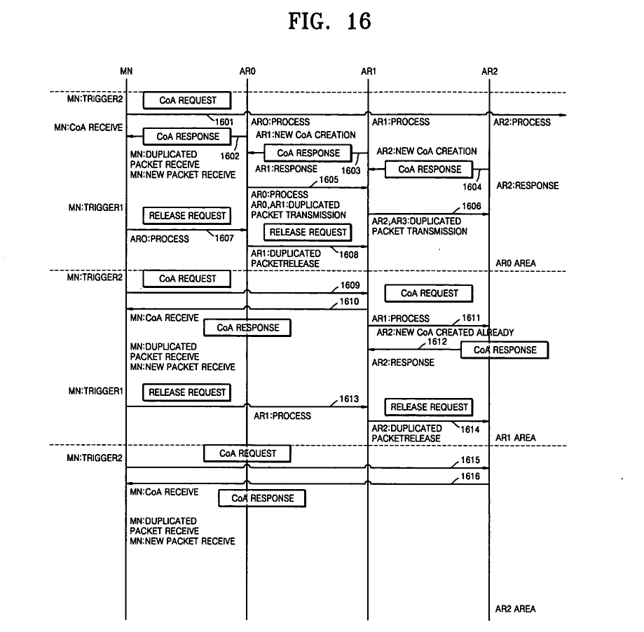

A basic handover process when final destination information is not in a CoA request message is shown in FIG. 14, a handover process in which two or more access routers are made to participate in tunneling for a fast-moving terminal regardless of an L2 trigger when there is no final destination information is shown in FIG. 15, and a handover process when there is final destination information is shown in FIG. 16.

FIG. 14 is a diagram of a message flow according to a tunneling operation method according to an embodiment of the present invention. Referring to FIG. 14, a mobile node in the AR0 area transmits a CoA request to AR0, which is a current access router at an L2 trigger 2 time point in operation 1401. AR0 which receives the request transmits a CoA response to the mobile node by using a CoA which AR0 has already generated in the previous operation in operation 1402.

The mobile node which receives the CoA response from AR0 begins to be able to receive a duplicated packet and a new packet from AR0.

The AR0 which receives the CoA request predicts a next access router because there is no final destination information, and transmits a new CoA request to AR1 which is the predicted access router in operation 1403. The new access router AR1 which receives the new CoA request generates a new CoA and transmits a new CoA response to AR0 in operation 1404.

AR0 which receives the new CoA response transmits a duplicated packet directed to the mobile node to AR1 in operation 1405.

Next, the mobile node moves and then transmits a release request to current access router AR0 at an L2 trigger 1 time point in operation 1406, and AR0 which receives the request transfers this release request to AR1 in operation 1407. Then, AR1 which receives this release request transmits a duplicated packet, which AR1 received from AR0 and stored previously, to the mobile node by using the generated CoA.

This process is performed when the mobile node is both in an AR1 area and in an AR2 area in the same manner.

FIG. 15 is a diagram of a message flow according to a tunneling operation method according to another embodiment of the present invention. Referring to FIG. 15, a mobile node in the AR0 area transmits a CoA request to AR0, which is a current access router at an L2 trigger 2 time point in operation 1501. AR0 which receives the request, first transmits a CoA response to the mobile node by using a CoA which AR0 has already generated in the previous operation. The mobile node which receives the CoA response from AR0 begins to be able to receive a duplicated packet and a new packet from AR0.

Then, AR0 predicts a next access router because there is no final destination information in the CoA request received from the mobile node, and transmits another CoA request to AR1, which is the predicted access router, as a destination in operation 1503. AR1 which receives the CoA request from the AR0 checks the speed field of the received CoA request message, and if it is determined that the speed is very high, again predicts another next access router and transmits a CoA request to the predicted access router AR2 as a destination in operation 1504.

AR1 which receives the CoA request from AR0 generates a new CoA and transmits a CoA response to AR0 in operation 1505. AR2 which receives the CoA request from AR1 generates a new CoA and transmits a CoA response to AR1 in operation 1506.

AR0 which receives the CoA response transmits a duplicated packet directed to the mobile node to AR1 in operation 1507 and AR1 which receives the duplicated packet from AR0 transmits the duplicated packet to AR2 in operation 1508.

Next, the mobile node transmits a release request to AR0 which is a current access router at L2 trigger 1 time point in operation 1509. AR0 which receives the request transmits the release request to AR1 in operation 1510. Then, AR1 transmits the duplicated packet, which AR1 received from AR0 and stored in the previous operation, to the mobile node.

Next, if the mobile node moves to the AR1 area and transmits a CoA request to AR1 at an L2 trigger 2 time point in operation 1511, AR1 transmits a CoA response to the mobile node, by using a CoA which AR1 has already generated in the previous operation, in operation 1512, and AR1 transmits another CoA request to AR2 in operations 1513. AR2 which receives the request transmits a CoA response to AR1 by using an already generated CoA in operation 1514.

Then, if the mobile node transmits a release request to AR1 at an L2 trigger 1 time point in operation 1515, AR1 transmits the release request to AR2 in operation 1516, and AR2, which receives the release request, transmits a duplicated packet, which AR2 received from AR1 and stored previously, to the mobile node.

Next, if the mobile node moves to the AR2 area and transmits a CoA request to AR2 at an L2 trigger 1 time point in operation 1517, AR2 transmits a CoA response to the mobile node by using a CoA which AR2 has already generated, in operation 1518, and the mobile node which receives the response begins to be able to receive a duplicated packet and a new packet from AR2.

FIG. 16 is a diagram of a message flow according to a tunneling operation method according to another embodiment of the present invention. Referring to FIG. 16, a mobile node in the AR0 area transmits a CoA request with a specified access router as a final destination, to an access router at an L2 trigger 2 time point in operation 1601. This CoA request is transmitted to the final destination access router through access routers on a path to the final destination access router, in a hop by hop method.

AR0, which receives the CoA request, transmits a CoA response which AR0 has already generated in the previous operation to the mobile node in operation 1602. If the mobile node thus receives the CoA response, the mobile node can receive a new packet as well as a duplicated packet from AR0.

AR1, which receives the CoA request, generates a first new CoA and transmits a first CoA response to AR0 in operation 1603 and AR2, which receives the CoA request, generates a second new CoA and transmits a second CoA response to AR1 in operation 1604.

AR0, which receives the first CoA response, transmits a duplicated packet directed to the mobile node to AR1 in operation 1605 and AR1, which receives the duplicated packet from AR0, transmits the duplicated packet to AR2 in operation 1606.

If the mobile node transmits a release request to AR0 at an L2 trigger 1 time point in operation 1607, AR0 transmits this release request to AR1 in operation 1608, and if AR1 receives the release request, AR1 transmits a duplicated packet, which AR1 received from AR0 and stored previously, to the mobile node.

Next, if the mobile node moves to the AR1 area and transmits a CoA request to AR1 at an L2 trigger 2 time point in operation 1609, AR1 transmits a CoA response to the mobile node by using a CoA which AR1 has already generated in the previous step, in step 1610, and AR1 transmits a CoA request to AR2 in operation 1611. AR2 which receives the CoA request transmits a CoA response to AR1 by using an already generated CoA in operation 1612.

Then, if the mobile node transmits a release request to AR1 at an L2 trigger 1 time point in operation 1613, AR1 transmits the request to AR2 in operation 1614, and AR2 which receives this release request, transmits a duplicated packet which AR2 received from AR1 and stored previously, to the mobile node.

Next, if the mobile node moves to the AR2 area and transmits a CoA request to AR2 at an L2 trigger 1 time point in operation 1615, AR2 transmits a CoA response to the mobile node by using a CoA which AR2 has already generated, in operation 1616, and the mobile node which receives the response begins to be able to receive a duplicated packet and a new packet from AR2.

As described above, with aspects of the present invention, smooth service can be provided for real-time data transmission for a fast-moving terminal which will be a major application of IPv6 in the future. The methods described can be applied to all traffic of a fast-moving terminal and its advantage can be displayed more particularly in a user datagram protocol (UDP) packet in which real-time availability is more important. It is because a UDP packet does not receive an acknowledge packet such that even in a packet forwarding process using tunneling, that a smaller burden is put on a router, and the transmission mechanism is relatively simpler than that of TCP such that the packet processing in each router is easier.

The related art was a passive method by which when a router advertisement signal is received or an L2 trigger occurs, handover begins. Compared to this, the method of embodiments of the present invention performs active handover based on the directivity of a fast-moving terminal such that the method has an advantage that the mobile node itself that can know the state of the mobile node most accurately can actively lead the handover. Through this method, packet loss rate can be reduced to zero, and real-time applications such as VoIP and real-time streaming can be provided reasonably in mobile IPv6 environments.

In addition, in an aspect of the present invention, the method is implemented completely by installing an agent program formed by software in each mobile node and access router. More accurate service can also be provided by interoperating with a GPS or speed measuring system.

The invention can be realized as a computer-readable code written on a computer-readable recording medium. The computer-readable recording medium includes nearly all kinds of recording devices, in which data can be stored in a computer-readable manner. For example, the computer-readable recording medium includes ROM, RAM, CD-ROM, a magnetic tape, a floppy disk, an optical data storage, or a carrier wave (e.g., data transmission through the Internet). In addition, the computer-readable recording medium can be distributed over a plurality of computer systems connected to one another in a network so that data written thereon can be read by a computer in a decentralized manner. Functional programs, codes, and code segments necessary for realizing the present invention can be easily inferred from the prior art by one of ordinary skill in the art that the present invention pertains to.

Embodiments of the present invention are designed for a fast-moving terminal having predetermined directivity such as a vehicle using a freeway or a terminal in a high-speed train and does not have any problem in using it together with the conventional high-speed handover method.

Applications applying mobile IPv6 to vehicles together with home networks are expected to increase in the future, and applying the method and apparatus described above can sufficiently provide services demanded by service providers and users, for example, listening to the Internet radio broadcasting or viewing film in a high-speed train, periodically checking the state of a vehicle, and using the Internet phone.

1. A handover method, comprising:
requesting handover to an access router based on a moving speed of a mobile node.

2. The handover method of claim 1, wherein the requesting handover comprises:
obtaining moving speed data of the mobile node by measuring the moving speed of the mobile node or by calculating the moving speed of the mobile node based on time information of a time when the mobile node is connected to IP of routers visited by the mobile node.

3. The handover method of claim 2, wherein the requesting handover comprises:
determining a handover mode for a fast-moving terminal traveling above a predetermined speed, which begins a handover operation before an L2 trigger of the mobile node based on the obtained moving speed data; and
generating and transmitting a care-of address (CoA) request message before the L2 trigger of the mobile node if the handover mode for the fast-moving terminal is determined.

4. A handover method, comprising:
performing tunneling so that access routers on a path to a destination access router participate in tunneling, based on destination information of the destination access router of a mobile node.

5. The handover method of claim 4, wherein the performing tunneling comprises:
receiving a care-of address (CoA) request message including the destination access router information from the mobile node;
transmitting the CoA request message having the destination access router as a destination;
receiving a CoA response message from an intermediate access router which receives the CoA request message; and
transmitting a duplicated packet of a packet directed to the mobile node, to the intermediate access router.

6. A handover method, comprising:
predicting an access router to be next connected by a mobile node, based on information on previous access routers visited by the mobile node, and performing handover by using the predicted access router.

7. The handover method of claim 6, wherein the predicting and performing handover comprises:
receiving a care-of address (CoA) message including information on the previous access routers visited by the mobile node, from the mobile node;
predicting the access router to be next connected by the mobile node, based on the access router information included in the CoA message;
transmitting a CoA request message having the predicted access router as a destination;
receiving a CoA response message from the predicted access router which receives the CoA request message; and
transmitting a duplicated packet of a packet directed to the mobile node, to the predicted access router.

8. The handover method of claim 6, wherein the predicting and performing handover comprises:
receiving a CoA message including information on the previous access routers visited by the mobile node, from a current access router;
predicting the next access router to be connected by the mobile node, based on moving speed information of the mobile node included in the CoA message;
transmitting a CoA request message having the predicted access router as a destination;
receiving a CoA response message from the predicted access router which receives the CoA request message; and
transmitting a duplicated packet of a packet directed to the mobile node, to the predicted access router.

9. A handover method, comprising:
receiving a care-of address (CoA) request message, which is received from a mobile node by a previous access router, from the previous access router, generating a CoA, and receiving a duplicated packet directed to the mobile node from the previous access router using the generated CoA at a first time point of an L2 trigger; and
transmitting the duplicated packet using the CoA in response to a release request from the mobile node at a second time point of the L2 trigger.

10. The handover method of claim 9, wherein the first time point of the L2 trigger indicates a time when strength of a first L2 signal corresponding to a cell, which the mobile node belongs to currently, drops below a lower threshold and at the same time the strength of a second L2 signal corresponding to a next cell rises above an upper threshold, and the second time point of the L2 trigger indicates a time when the strength of the first L2 signal corresponding to the cell which the mobile node belongs to currently drops below the upper threshold and at the same time the strength the second L2 signal corresponding to the next cell rises above the lower threshold.

11. A handover apparatus provided to a mobile node, comprising:
a handover booster which requests handover to an access router based on a moving speed of the mobile node.

12. The handover apparatus of claim 11, wherein the handover booster comprises:
a moving speed calculation/measurement unit which calculates and/or measures the moving speed of the mobile node.

13. The handover apparatus of claim 12, wherein the moving speed calculation/measurement unit comprises:
a moving speed measurement unit which has a sensor to measure the moving speed of the mobile node.

14. The handover apparatus of claim 12, wherein the moving speed calculation/measurement unit comprises:
a moving speed calculation unit which calculates the moving speed of the mobile node based on time information of a time when the mobile node is connected to an IP of routers visited previously by the mobile node.

15. The handover apparatus of claim 12, wherein the handover booster comprises:
a handover mode determination unit which determines a handover mode for a fast-moving terminal comprising the mobile node which begins the handover operation before an L2 trigger of the mobile node based on the moving speed from the moving speed calculation/measurement unit; and
a handover request unit which if the handover mode determination unit determines the handover mode for the fast-moving terminal, generates and transmits a CoA request message before the L2 trigger of the mobile node.

16. The handover apparatus of claim 15, wherein the CoA request message includes the moving speed of the mobile node and information providing a destination of the mobile node.

17. A handover apparatus provided to an access router, comprising:
a pre-handover agent which performs tunneling so that access routers on a path to a destination access router participate in tunneling, based on destination access router information of a mobile node.

18. The handover apparatus of claim 17, wherein a duplicated packet directed to the mobile node is transmitted to the access routers participating in the tunneling.

19. A handover apparatus provided to an access router comprising:
a pre-handover agent which predicts a next access router to be connected by a mobile node, based on information on previous access routers visited by the mobile node, and requests handover to the predicted next access router.

20. The handover apparatus of claim 19, wherein the pre-handover agent forwards a care of address for the mobile node to the next access router such that the care of address can be used immediately when the mobile node enters within an area managed by the next access router.

21. A method of managing handover of a mobile terminal in a mobile network having access routers, the method comprising:
determining a moving speed of the mobile terminal;
determining a handover mode as a fast handover mode according to the moving speed being determined above a threshold; and
generating and transmitting a fast handover message to the mobile network when the fast handover mode is determined, wherein the fast handover message is transmitted before an L2 trigger of the mobile terminal.

22. A method of managing handover of a mobile terminal in a mobile network having access routers, the method comprising:
performing active handover between the mobile terminal and the mobile network based on a direction of travel of the mobile terminal and a moving speed of the mobile terminal.
